(19) United States
(12) Patent Application Publication
(10) Pub. No.: US 2011/0167422 A1
(43) Pub. Date: Jul. 7, 2011

(54) VIRTUALIZATION APPARATUS

(75) Inventors: Young Ik Eom, Gyeonggi-do (KR); Jung Han Kim, Gyeonggi-do (KR); Byoung Hong Lim, Gyeongsangbuk-do (KR); Tae Hyoung Kim, Gyeonggi-do (KR); In Hyeok Kim, Seoul (KR)

(73) Assignee: Sungkyunkwan University Foundation for Corporate Collaboration, Gyeonggi-do (KR)

(21) Appl. No.: 12/707,808

(22) Filed: Feb. 18, 2010

(30) Foreign Application Priority Data
Jan. 5, 2010 (KR) 10-2010-0000376

(51) Int. Cl. G06F 9/455

(52) U.S. Cl. 718/1

(57) ABSTRACT

A virtualization apparatus includes one or more guest machines each comprised of a guest kernel and a guest user process, a hypervisor module installed in a host kernel and handling a request of the guest machine with regard to the virtualization apparatus, and a virtual processor supporting the guest machine to serve as a host user process and handling an interrupt and a switching of the guest machine, wherein address spaces of the guest kernel and the guest user process are designed to be separated from each other.

### FIELD OF THE INVENTION

The present disclosure relates to a virtualization apparatus. More particularly, the present disclosure relates to a virtualization apparatus for virtualizing a guest machine by using a separation scheme of kernel/user address space.

### BACKGROUND OF THE INVENTION

A virtualization technology has been introduced to enable one main-frame server to be virtually divided into and used on multiple machines. This technology has been conceived in view of the fact that actual utilization of a server is equal to or less than about 10%-20%, and enables multiple servers to be operated in a virtual machine existing on one physical server. With this technology, it is possible to increase the actual utilization of the server and maintain security of the server.

According to such a virtualization technology, a virtualization layer is created on a host operating system (OS) or multiple logical virtual machines (VM) are created on the virtualization layer by using a virtual machine monitor (VMM), which directly provides the virtualization layer, or a hypervisor. In each of the multiple virtual machines, a guest operating system may be installed. In each guest operating system, a program to be supported by the guest operating system is installed.

The virtualization technology may be divided into two technologies: a full-virtualization technology which does not require modification of a guest operating system; and a para-virtualization which requires modification of a guest operating system for minimizing a decrease in performance and enhancing security as compared to a conventional guest operating system.

The full-virtualization technology is executed in a virtual machine without modification of the guest operating system. In order to do so, emulation for implementing all elements of hardware in software or a code conversion technology for substituting general commands for commands requiring a special authority is used. The emulation is slowly performed since both the general commands and the special authority commands are implemented in software. However, since other processors or hardware platforms is applicable, the emulation has been often used to construct an embedded development environment.

The para-virtualization technology enables multiple operating systems to be executed in one hardware by modifying source codes of the operating systems. In this technology, when a general process operated on the operating system accesses a system resource, a system call is used. In particular, all commands requiring a special authority are removed from a guest operating system by directly modifying a source code of an operating system using the commands requiring the special authority such as an execution mode conversion, interrupt/exception handling, and the like and by substituting the system call by a hyper call of a similar form. In this way, the guest operating system can be comprised of general commands only. Further, unlike the full-virtualization technology which is executed based on the emulation or the code conversion, in the para-virtualization technology, commands are directly executed in a processor, resulting in less decrease in performance.

However, in a conventional virtualization apparatus employing such a virtualization technology, a process and an operating system are designed to exist in the same address space, and, thus, it is possible to protect only a memory between a host operating system (kernel) and a host process (user process) and a memory between host user processes. Therefore, the conventionally designed virtualization apparatus, it is difficult to protect a memory between a host and a guest, a memory between a guest kernel and a guest user process, and a memory between guest machines.

Further, in the conventional virtualization apparatus, there exists a separate guest machine serving as a processor or a specific domain for performing a virtualization process of guest machines and an interrupt or a request of a guest process (user process) for a physical apparatus is handled through a guest operating system (kernel), a hypervisor, and a host, whereby the virtualization process is slowly performed.

### BRIEF SUMMARY OF THE INVENTION

In accordance with an embodiment of the present invention, there is provided a virtualization apparatus capable of simplifying process architectures for a processor virtualization, a memory virtualization, and an apparatus virtualization by designing a guest machine to be operated in a user mode of a host.

In view of the foregoing, the present disclosure provides a virtualization apparatus comprising one or more guest machines each comprised of a guest kernel and a guest user process, a hypervisor module installed in a host kernel and handling a request of the guest machine with regard to the virtualization apparatus, and a virtual processor supporting the guest machine to serve as a host user process and handling an interrupt and a switching of the guest machine, wherein address spaces of the guest kernel and the guest user process are designed to be separated from each other.

In accordance with the present disclosure, a guest machine is designed to be operated in a host user process so as to simplify procedures of a host-guest conversion, an interrupt handling, a memory paging, and an apparatus management, whereby a speed of a virtualization process can be improved.

Moreover, in accordance with the present disclosure, an address space of a guest kernel and an address space of a guest user process is separated from each other, and, thus, it is possible to effectively protect a memory between a host and a guest, a memory between the guest kernel and the guest user process, and a memory between guest user processes.

### BRIEF DESCRIPTION OF THE DRAWINGS

The disclosure may best be understood by reference to the following description taken in conjunction with the following figures:

FIG. 1 is a view of a virtualization apparatus in accordance with an embodiment of the present invention;

FIG. 2 is a configuration view for explaining a memory protection method of a virtualization apparatus in accordance with an embodiment of the present invention;

FIG. 3 is a view for explaining a host-guest conversion process of a virtualization apparatus in accordance with an embodiment of the present invention;

FIG. 4 is a view for explaining an interrupt delivery process of a virtualization apparatus in accordance with an embodiment of the present invention;

FIG. 5 is a view for explaining a shadow paging method of a virtualization apparatus in accordance with an embodiment of the present invention; and

FIG. 6 is a view for explaining an apparatus virtualization method using a virtual driver of a virtualization apparatus in accordance with an embodiment of the present invention.

### DETAILED DESCRIPTION OF THE INVENTION

Hereinafter, embodiments of the present invention will be described in detail with reference to the accompanying drawings so that the present invention may be readily implemented by those skilled in the art. However, it is to be noted that the present invention is not limited to the embodiments but can be realized in various other ways. In the drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements.

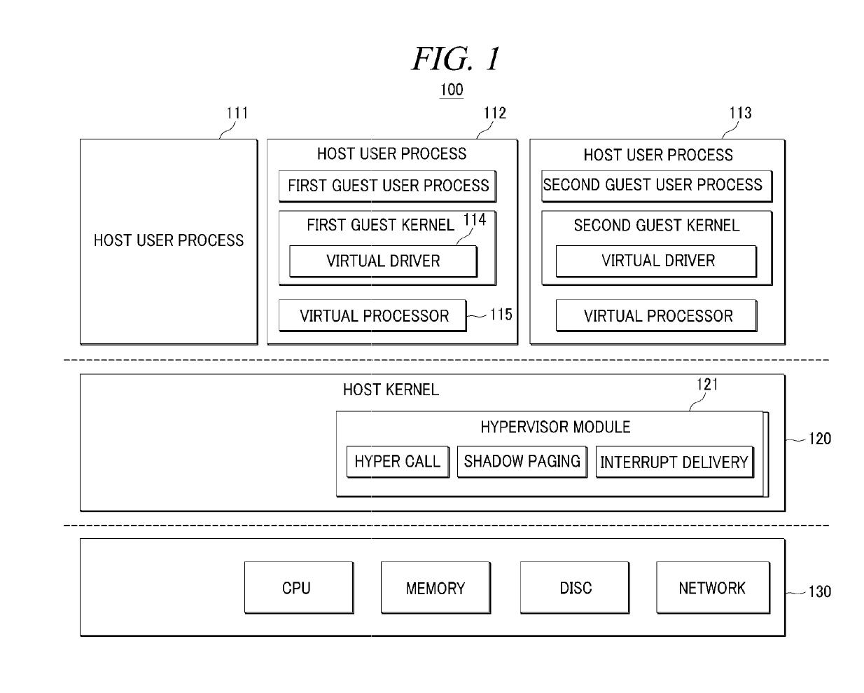

FIG. 1 is a view of a virtualization apparatus in accordance with an embodiment of the present invention.

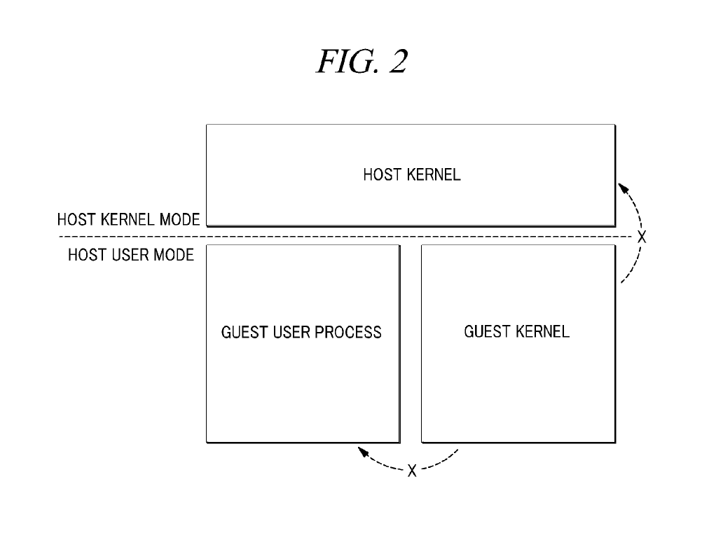

FIG. 2 is a configuration view for explaining a memory protection method of a virtualization apparatus 100 in accordance with an embodiment of the present invention.

As depicted in FIG. 1, the virtualization apparatus 100 in accordance with an embodiment of the present invention includes at least one of host user processes 111, 112, and 113 in which a guest processor 115 supporting a guest machine to be virtualized is implemented and a virtual driver 114 managing and controlling a virtual apparatus is included, a host kernel 120 including a hypervisor module 121 supporting at least one guest machine serving as a host user process to be para-virtualized, and a physical apparatus 130.

Elements illustrated in FIG. 1 in accordance with the embodiment of the present invention represent software elements or hardware elements such as a field programmable gate array (FPGA) or an application specific integrated circuit (ASIC), and these elements perform predetermined roles. However, the elements are not limited to software or hardware. Further, the elements may be configured to exist in an addressable storage medium, or to reproduce one or more processors. For example, the elements include elements such as software elements, object-oriented software elements, class elements, and task elements, processes, functions, properties, procedures, subroutines, segments of a program code, drivers, firmware, a microcode, a circuit, data, a database, data structures, tables, arrays, and variables.

Herein, functions provided by the elements or in the elements may be provided either by a smaller number of combined larger elements or by a larger number of divided smaller elements.

In the virtualization apparatus 100 in accordance with the embodiment of the present invention, the guest machine is designed to operate in the virtual processor 115, which is a virtual architecture, and serves as a host user processor.

It is illustrated, for example, in FIG. 1 that the host user process 111 which is an original host user, the host user process 112 in which a first guest machine is installed, and the host user process 113 in which a second guest machine is installed are configured as an upper layer of the host kernel 120.

Each of the guest machines is comprised of a guest user process and a guest kernel. For example, as illustrated in FIG. 1, the first guest machine includes a first guest user process and a first guest kernel, and the second guest machine includes a second guest user process and a second guest kernel.

The host kernel 120 includes a hypervisor module 121 which performs a hypercall function, a shadow paging function, and an interrupt delivery function in order to support virtualization of a guest machine.

The physical apparatus 130 includes a memory, a disc, and a network interface.

Particularly, in the virtualization apparatus 100 in accordance with the embodiment of the present invention, an address space of the guest kernel and an address space of the guest user process of the guest machine are designed to be separated from each other, and, thus, it is possible to protect the memory.

To be specific, as illustrated in FIG. 2, since the guest kernel and the guest user process are operated in a host user mode, they cannot randomly access the host kernel. Further, since the guest kernel and the guest user process independently exist in a memory map, they cannot directly access each other. As described above, since the address space of the guest kernel and the address space of the guest user process are separated from each other, it is possible to protect a memory between the host and the guest, a memory between the guest kernel and the guest user process, and a memory between the guest machines inside the virtualization apparatus 100.

Furthermore, in the virtualization apparatus 100 in accordance with the embodiment of the present invention, a process for each and every access is performed by using an address translation function of the host kernel. Therefore, in accordance with the present invention, unlike a conventional process for access which has been performed by using four privileged levels in an Intel x86 processor, it is possible to effectively protect a memory by using just two run levels comprised of a host kernel mode and a host user mode.

The virtualization apparatus 100 in accordance with the embodiment of the present invention performs a processor virtualization, a memory virtualization, and an apparatus virtualization.

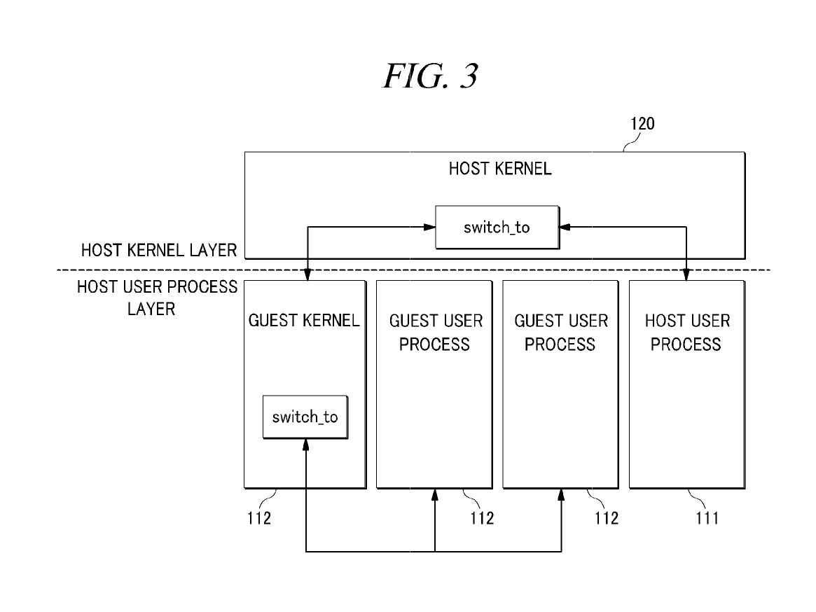

Hereinafter, there will be explained a virtualization method of a virtualization apparatus in accordance with an embodiment of the present invention with reference to FIGS. 3 to 6.

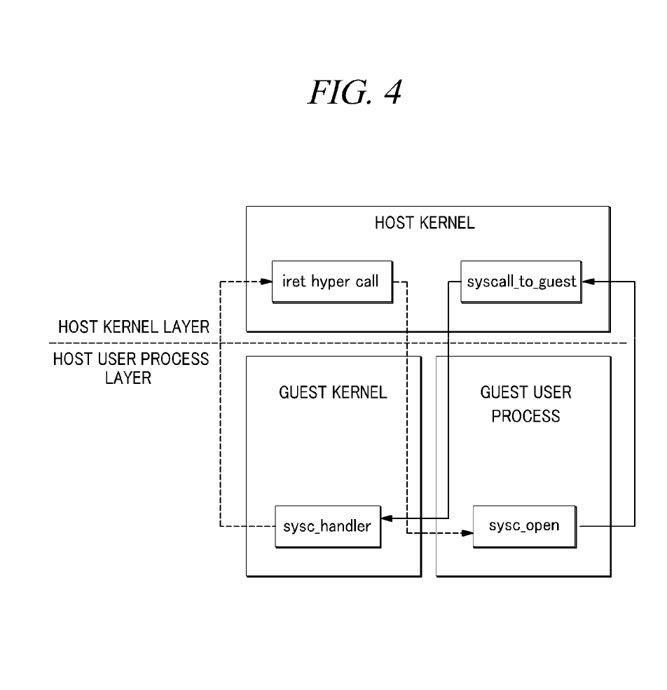

First of all, a processor virtualization method of the virtualization apparatus 100 will be explained with reference to FIGS. 3 and 4.

FIG. 3 is a view for explaining a host-guest conversion process of a virtualization apparatus in accordance with an embodiment of the present invention.

FIG. 4 is a view for explaining an interrupt delivery process of a virtualization apparatus in accordance with an embodiment of the present invention.

In the virtualization apparatus 100 in accordance with the embodiment of the present invention, the virtual processor 115 implemented in the host user process 112 support a switching process and an interrupt handling in order for the processor to be para-virtualized.

Generally, in the virtualization apparatus 100, a host-guest conversion occurs frequently whenever a help of the host is needed such as when a hardware interrupt occurs and the host should handle it, when the guest changes a kernel mode stack to change a page directory or to switch a context, and when a virtual apparatus is used.

At this time, in the virtual apparatus 100 in accordance with the embodiment of the present invention, the guest kernel serves as a host user process, and, thus, the host-guest conversion (i.e., switching) is quickly carried out without modification of a code.

To be specific, as illustrated in FIG. 3, a conversion between the guest user processes is carried out by using “switch_to” function of the guest kernel, and a conversion between the guest kernel serving as a host user process and the original host user process is carried out by using “switch_to” function of the host kernel.

In FIG. 3, it is illustrated that the host kernel 120 implemented in the host kernel layer carries out the conversion between the host user process 112 in which the first guest machine is installed and the original host user process 111. Further, it is illustrated that the first guest kernel included in the first guest machine 112 carries out the conversion between the first guest user processes.

Furthermore, in the virtualization apparatus 100, when the hardware interrupt occurs, the host kernel handles the interrupt and then delivers the interrupt to the guest kernel through the hypervisor module 121. At this time, since the guest kernel is operated in the host user mode, it does not carry out an actual hardware process for the delivered interrupt, whereby an unnecessary overhead is not created.

Moreover, in the virtualization apparatus 100 in accordance with the embodiment of the present invention, since the address space of the guest kernel and the address space of the guest user process are separated from each other, when a software interrupt occurs, the interrupt of the guest user process to the guest kernel is handled by the host kernel.

To be specific, as illustrated in FIG. 4, when the guest user process calls a system call by using “sys open” function, the hypervisor module 121 of the host kernel handles the system call of the guest user process through a system call handler. At this time, the host kernel delivers the system call to the guest kernel by using “syscall_to_guest” function. Then, the guest kernel handles the system call of the guest user process and requests a conversion of the guest process from the host kernel by using “fret hyper call” instruction through “sys handler” function. In this way, the host kernel transfers a control to the guest user process.

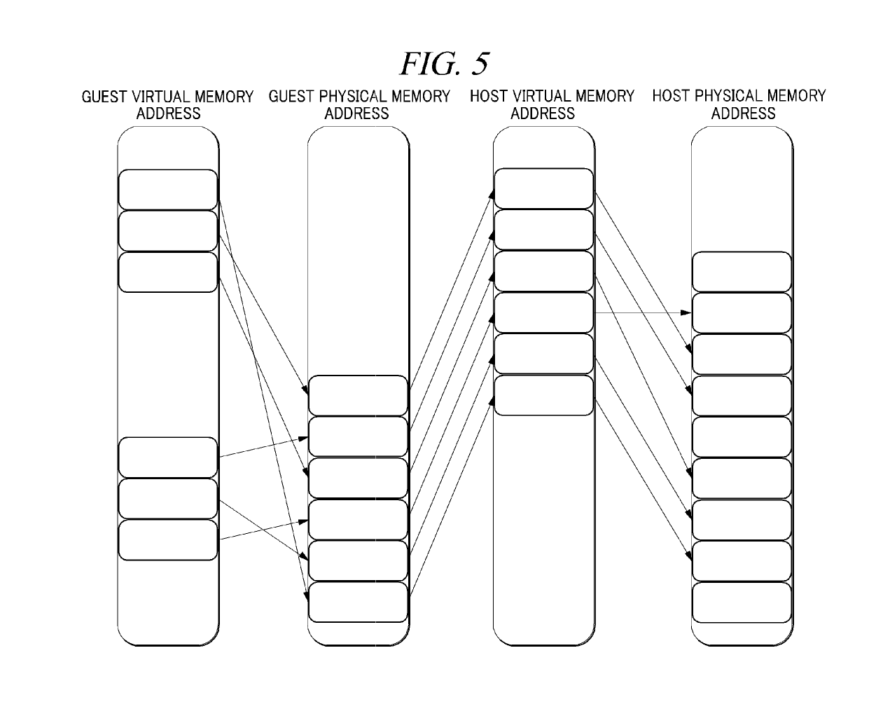

Hereinafter, there will be explained a memory virtualization method of a virtualization apparatus in accordance with an embodiment of the present invention with reference to FIG. 5.

FIG. 5 is a view for explaining a shadow paging method of a virtualization apparatus in accordance with an embodiment of the present invention.

The virtualization apparatus 100 in accordance with the embodiment of the present invention virtualizes a memory by using a shadow paging method in order to effectively manage separated address spaces of the guest machine.

At this time, in the virtualization apparatus 100 in accordance with the embodiment of the present invention, the guest kernel creates a page table and a page directory managing a virtual physical memory space allocated for booting. Further, the guest kernel and the guest user process are operated in the virtual physical memory space based on the created page directory and page table. For reference, a virtual memory space is divided into fixed-size blocks, each of which is called “page.” Furthermore, stored in the page table is page information of the process, i.e., a virtual memory address and its matched physical memory address. Each process has one page table.

In the virtualization apparatus 100 in accordance with the embodiment of the present invention, the host kernel manages a shadow page table corresponding to the page table of the guest kernel.

For example, as illustrated in FIG. 5, a guest virtual memory address is matched with a guest physical memory address, and such matching information between the guest virtual and physical memory addresses is stored in a guest page table. Further, in the embodiment of the present invention, the guest physical memory address is matched with a host virtual memory address, and such matching information between the guest physical memory address and the host virtual memory address is stored in the shadow page table. Furthermore, the host virtual memory address is matched again with a host physical memory address, i.e., an actual physical memory address, and such matching information between the host virtual and physical memory addresses is stored in a host page table.

The hypervisor module 121 in accordance with the embodiment of the present invention handles a page fault in order to synchronize the page table of the guest kernel (i.e., guest page table) and the shadow page table.

To be specific, when a page fault occurs, if it occurs at a guest address, the hypervisor module 121 of the host kernel in accordance with the embodiment of the present invention delivers the page fault to the guest kernel. Then, a page fault handler of the guest kernel is operated in the host user mode, and, thus, the page fault handler is allocated a new page by using “get_user_pages” function instead of being provided with actual page fault handling. That is, the guest kernel requests a page by requesting a hyper call from the host kernel using “get_user_pages” function. Thereafter, the host kernel allocates a page of an actual physical memory in response to the requested hyper call and synchronizes the shadow page table with the allocated page of an actual physical memory.

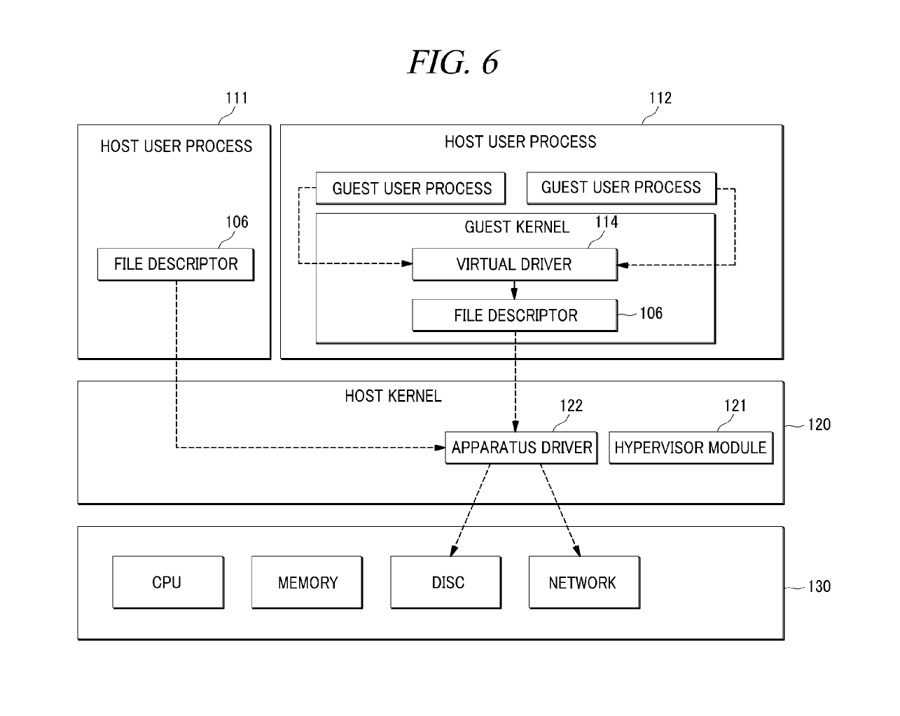

Hereinafter, there will be explained an apparatus virtualization method of a virtualization apparatus in accordance with an embodiment of the present invention with reference to FIG. 6.

FIG. 6 is a view for explaining an apparatus virtualization method using a virtual driver of a virtualization apparatus in accordance with an embodiment of the present invention.

In the virtualization apparatus 100 in accordance with the embodiment of the present invention, the guest machine serves as a host user process, and, thus, the guest machine's access to a physical apparatus is controlled by an input/output system call handled from a file descriptor in the same manner as the other host user process (i.e., original host user process). That is, the guest user process recognizes a file descriptor 106 provided by the host as an actual hardware apparatus.

To be specific, as illustrated in FIG. 6, in the virtualization apparatus 100 in accordance with the embodiment of the present invention, the virtual driver 114 of the guest kernel carries out abstraction of the file descriptor 106 and provides it to the guest user process. At this time, in the virtualization apparatus 100 in accordance with the embodiment of the present invention, a virtual driver such as a console, a block, a network, and a frame buffer may be provided according to a characteristic of the virtual driver 114.

Accordingly, a specific guest machine serving as a driver in a conventional virtual apparatus such as Xen is not necessary and an internet domain communication (IDC) for handling a driver between guest machines is not necessary. Therefore, it is possible to effectively manage the apparatus regardless of the number of guest machines.

The embodiment of the present invention can be embodied in a storage medium including instruction codes executable by a computer such as a program module executed by the computer. A computer readable medium can be any usable medium which can be accessed by the computer and includes all volatile/non-volatile and removable/non-removable media. Further, the computer readable medium may include all computer storage and communication media. The computer storage medium includes all volatile/non-volatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes a certain information transmission medium.

The system and method of the present invention has been explained in relation to a specific embodiment, but its components or a part or all of its operation can be embodied by using a computer system having general-purpose hardware architecture.

The above description of the present invention is provided for the purpose of illustration, and it would be understood by those skilled in the art that various changes and modifications may be made without changing technical conception and essential features of the present invention. Thus, it is clear that the above-described embodiments are illustrative in all aspects and do not limit the present invention. For example, each component described to be of a single type can be implemented in a distributed manner. Likewise, components described to be distributed can be implemented in a combined manner.

The scope of the present invention is defined by the following claims rather than by the detailed description of the embodiment. It shall be understood that all modifications and embodiments conceived from the meaning and scope of the claims and their equivalents are included in the scope of the present invention.

What is claimed is:

1. A virtualization apparatus comprising:
one or more guest machines each comprised of a guest kernel and a guest user process;
a hypervisor module installed in a host kernel and handling a request of the guest machine with regard to the virtualization apparatus; and
a virtual processor supporting the guest machine to serve as a host user process and handling an interrupt and a switching of the guest machine,
wherein address spaces of the guest kernel and the guest user process are designed to be separated from each other.

2. The virtualization apparatus of claim 1, wherein the host kernel is positioned at an upper address of each of the guest kernel and the guest user process.

3. The virtualization apparatus of claim 1, wherein the virtual processor delivers an interrupt occurring at the guest user process to the guest kernel through the host kernel so as to handle the interrupt.

4. The virtualization apparatus of claim 1, wherein the guest kernel includes a virtual driver which carries out abstraction of a file descriptor of the host user process and supports the guest user process to recognize the file descriptor as an actual apparatus.

5. The virtualization apparatus of claim 1, wherein when a page fault corresponding to an address of the guest machine occurs, the hypervisor module delivers the page fault to the guest kernel, receives a hyper call requesting a new page in response to the delivery of the page fault, and allocates an actual physical page.

6. The virtualization apparatus of claim 5, wherein the hypervisor module creates a shadow page table to be matched with a page table of the guest kernel and synchronizes the shadow page table with the allocated page of an actual physical memory after allocating the actual physical page.
